(19) United States
(12) Patent Application Publication
(10) Pub. No.: US 2014/0168146 A1
(43) Pub. Date: Jun. 19, 2014

(54) TOUCH PANEL

(71) Applicant: PANASONIC CORPORATION, Osaka (JP)

(72) Inventors: Keishiro MURATA, Kyoto (JP); Koji TANABE, Osaka (JP)

(73) Assignee: PANASONIC CORPORATION, Osaka (JP)

(21) Appl. No.: 14/083,288

(22) Filed: Nov. 18, 2013

(30) Foreign Application Priority Data
Dec. 14, 2012 (JP) 2012-273172
Sep. 19, 2013 (JP) 2013-193819

(51) Int. Cl. G06F 3/044

(52) U.S. Cl. CPC G06F 3/044
USPC 345/174

(57) ABSTRACT

A touch panel includes first conductive layers being light-transmittable, and second conductive layers being light-transmittable and facing the first conductive layers with a gap. Each of the first conductive layers includes a resin being light-transmittable, metal filaments dispersed in the resin, and fine metal particles dispersed in the resin. The fine metal particles electrically connect the metal filaments to each other. The touch panel has a secure operability.

### TECHNICAL FIELD

This invention relates to a touch panel to be used mainly for an operating part of various electronic devices.

### BACKGROUND ART

In recent years, electronic devices, such as a mobile phone and an electronic camera, are highly functionalized and diversified. Electronic devices installing a light-transmittable touch panel in front of a display element, such as a liquid crystal, are widely in use. A user, upon looking at a display of a display element behind through the touch panel, switches various functions of the electronic device by touching the panel with, e.g. a finger. For such touch panel, an easy view of the display element and a secure operability are required.

FIGS. 4 and 5 are a cross-sectional view and an exploded perspective view of ordinary touch panel 500 publicized in Japanese Patent Laid-Open Publication No. 2012-181828, respectively. Light-transmittable upper substrate 501 having a film shape is made of a resin sheet. Upper conductive layers 502 having a strip shape are arranged on an upper surface of upper substrate 501 in a left/right direction. Upper conductive layer 502 includes light-transmittable resin 502A and silver filaments 502B dispersed in the resin.

Upper electrodes 503 are made of conductive material, such as silver or carbon. Ends of upper electrodes 503 are connected to ends of upper conductive layers 502, and another ends of upper electrodes 503 extend to a right side periphery of upper substrate 501. A middle part of upper electrode 503 is laid out on an upper peripheral surface of upper substrate 501 in a left/right direction perpendicular to conductive layers 502.

Light-transmittable lower substrate 504 having a film shape is made of a resin sheet identical to the sheet of upper substrate 501. Lower conductive layers 505 having strip shapes are arranged on an upper surface of lower substrate 504. Lower conductive layer 505 includes silver filaments 505B dispersed in light-transmittable resin 505A. Lower conductive layers 505 are arranged in the front/back direction. Namely, upper conductive layers 502 and lower conductive layers 505 extend and cross perpendicularly to each other.

Lower electrode 506 is made of conductive material, such as silver or carbon, similar material for upper electrode 503. Ends of lower electrodes 506 are connected to right ends of lower conductive layers 505 and other ends of lower electrodes 506 extend to a right side periphery of lower substrate 504. A middle part of lower electrode 506 is laid out on a right upper surface of lower substrate 504.

Cover substrate 507 is a light-transmittable film. Upper substrate 501 is stacked on the upper surface of lower substrate 504, and cover substrate 507 is stacked on an upper surface of upper substrate 501. Lower substrate 504, upper substrate 501, and cover substrate 507 are adhesively stuck together, providing touch panel 500.

An operation of touch panel 500 will be explained below. Touch panel 500 is placed in front of a display element, such as a liquid crystal display, and is installed in an electronic device. Upper electrodes 503 and lower electrodes 506 extend to the right side periphery are electrically connected to an electronic circuit of the electronic device via a flexible wiring board and a connector.

When the electronic circuit applies a voltage sequentially to upper electrodes 503 and lower electrodes 506, a user has a finger touch an upper surface of cover substrate 507 corresponding to a display of the display element behind touch panel 500. Then, a capacitance between upper conductive layer 502 and lower conductive layer 505 changes at a point of the touching. The electronic circuit detects the change in the capacitance, and identifies the touched point based on the change in the capacitance, hence switching various functions of the electronic device.

For instance, when menus are displayed on the display element, the user touches a point of a desired menu on an upper surface of cover substrate 507 with a finger. Then, an electric charge partially flow to the finger, and changes the capacitance between upper conductive layer 502 and lower conductive layer 505. The electronic circuit detects the change in the capacitance and selects the desired menu.

In conventional touch panel 500, when touch panel 500 is operated under strong light, such as outdoor or under sunlight, the light is reflected diffusely by silver filaments 502B and 505B. Silver filaments 502B and 505B then look milk white, preventing the user from looking at the display of the display element. Moreover, touch panel 500 is demanded to have a secure operability.

### SUMMARY

A touch panel includes first conductive layers being light-transmittable, and second conductive layers being light-transmittable and facing the first conductive layers with a gap. Each of the first conductive layers includes a resin being light-transmittable, metal filaments dispersed in the resin, and fine metal particles dispersed in the resin. The fine metal particles electrically connect the metal filaments to each other.

The touch panel has a secure operability.

### BRIEF DESCRIPTION OF DRAWINGS

FIG. 1A is a plan view of a touch panel according to an exemplary embodiment of the invention.

FIG. 1B is a cross-sectional view of the touch panel at line 1B-1B shown in FIG. 1A.

FIG. 2 is an exploded perspective view of the touch panel according to the embodiment.

FIG. 3 is an enlarged cross-sectional view of the touch panel according to the embodiment.

FIG. 4 is a cross-sectional view of a conventional touch panel.

FIG. 5 is an exploded perspective view of the conventional touch panel.

### DETAIL DESCRIPTION OF PREFERRED EMBODIMENT

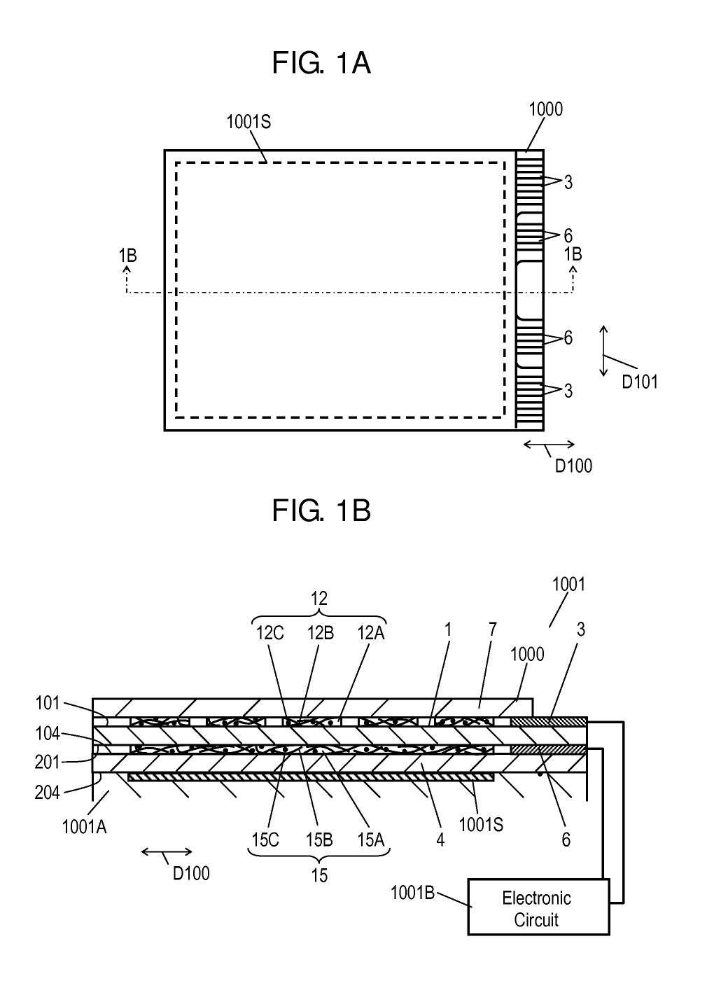

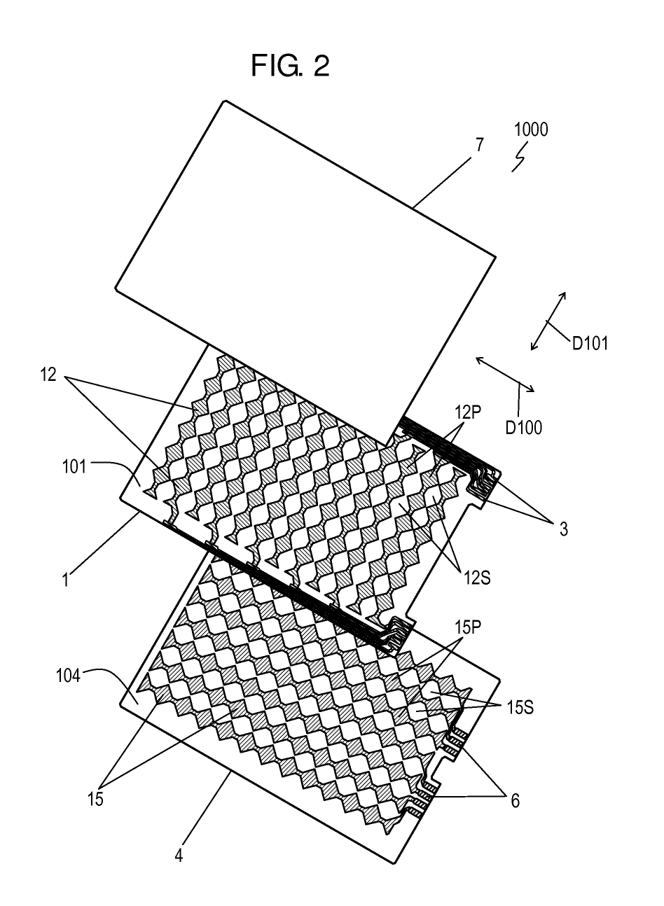

FIG. 1A is a plan view of touch panel 1000 according to an exemplary embodiment of the invention. FIG. 1B is a cross-sectional view of touch panel 1000 at line 1B-1B shown in FIG. 1A. FIG. 2 is an exploded perspective view of touch panel 1000. Upper substrate 1 is a light-transmittable sheet made of resin, such as polyethylene terephthalate, polyether sulfone, or polycarbonate. Upper conductive layers 12 are light-transmittable and have substantially strip shapes arranged on upper surface 101 of upper substrate 1 at predetermined pitches in predetermined direction D100, a left/right direction. Upper conductive layers 12 extend slenderly in direction D101 perpendicular to direction D100.

Upper electrodes 3 are made of conductive material, such as silver or carbon, formed by, e.g. printing or vaporizing copper foil. Each of ends of upper electrodes 3 is connected to respective one of ends of upper conductive layers 12 while each of other ends of upper electrodes 3 extends to a right side periphery of upper substrate 1. A middle part of upper electrode 3 is laid out along a periphery of upper surface 101 in the left/right direction, direction D100 perpendicular to direction D101 along which upper conductive layers 12 extend.

Lower substrate 4 is a light-transmittable sheet made of resin identical to that of upper substrate 1. Lower conductive layers 15 having substantially strip shapes arranged on upper surface 104 of lower substrate 4 at predetermined pitches in a front/back direction, direction D101. Lower conductive layers 15 extend slenderly in direction D100 perpendicular to direction D101.

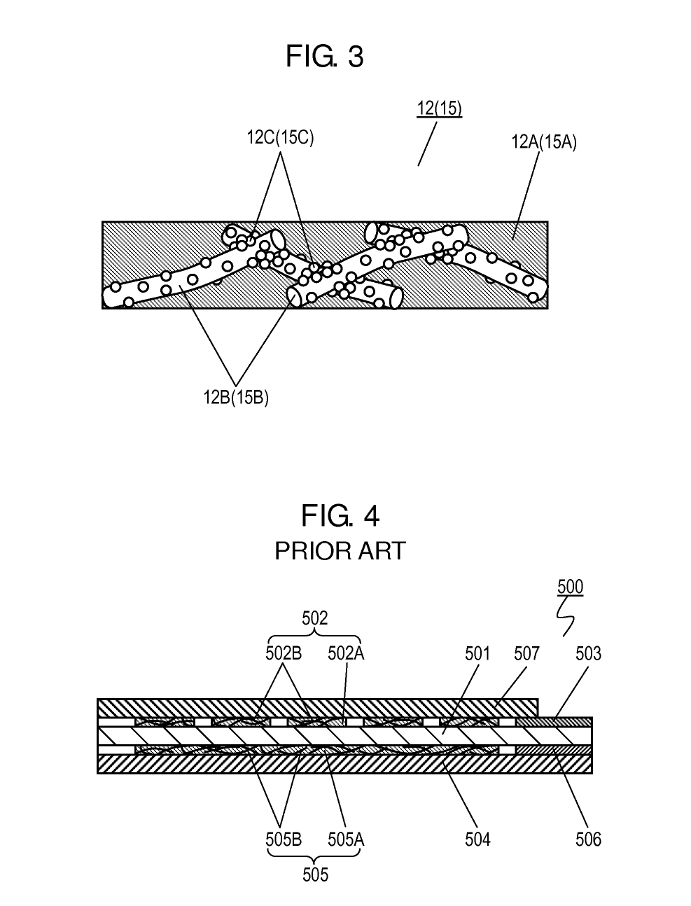

FIG. 3 is an enlarged cross-sectional view of upper conductive layer 12 and lower conductive layer 15. Upper conductive layer 12 includes resin 12A, metal filaments 12B dispersed in resin 12A, and fine metal particles 12C dispersed in resin 12A. Resin 12A is made of light-transmittable insulating resin, such as acrylic resin. Metal filaments 12B are made of conductive metal, such as silver. Fine metal particles 12C are made of conductive metal. Fine metal particles 12C are attached onto a surface of metal filament 12B. Metal filaments 12B are linked to each other with fine metal particles 12C. Metal filaments 12B are electrically connected to each other with fine metal particles 12C. In other words, fine metal particles 12C link metal filaments 12B to each other to electrically connect metal filaments 12B to each other.

Metal filaments 12B have diameters ranging from about 10 nm to 300 nm and lengths ranging from about 1 μm to 100 μm, and are made of conductive metal, such as single metal of silver or copper, silver alloy, or copper alloy. Metal particles 12C have an average diameter ranging from about 5 nm to 200 nm, and have particle shapes. Fine metal particles 12C are preferably made of silver or copper, but may be made of other conductive metal.

Lower conductive layer 15 includes resin 15A, metal filaments 15B dispersed in resin 15A, and fine metal particles 15C dispersed in resin 15A. Resin 15A is made of light-transmittable insulating resin, such as acrylic resin. Metal filament 15B is made of conductive metal, such as silver. Fine metal particle 15C is made of conductive metal. Fine metal particles 15C are attached onto a surface of metal filament 15B. Metal filaments 15B are linked to each other with fine metal particles 15C. Metal filaments are electrically connected to each other with fine metal particles 15C. In other words, fine metal particles 15C link metal filaments 15B to each other to electrically connect metal filaments 15B to each other. Lower conductive layers 15 extend slenderly in direction D100, as described above.

Metal filaments 15B have diameters ranging from about 10 nm to 300 nm and lengths ranging from about 1 μm to 100 μm, and are made of conductive metal, such as single metal of silver or copper, silver alloy, or copper alloy. Fine metal particles 15C have particle shapes, and have an average particle diameter ranging from about 5 nm to 200 nm. Fine metal particles 15C are preferably made of silver or copper, but may be made of other conductive metal.

Lower electrodes 6 are made of conductive material, such as silver, carbon, or copper foil, similarly to that of upper electrode 3. Each of ends of lower electrodes 6 is connected to respective one of ends of lower conductive layers 15 while each of other ends of lower electrodes 6 extends to a right side periphery of lower substrate 4. A middle part of each of lower electrodes 6 is laid out in a right side of upper surface 104 of lower substrate 4.

Each of upper conductive layers 12 includes rectangular portions 12P connected to each other to extend in direction D101. Spaces 12S having substantially rectangular shapes are provided between rectangular portions 12P. Each of lower conductive layers 15 includes rectangular portions 15P connected to each other to extend in direction D100. Spaces 15S having substantially rectangular shapes are provided between rectangular portions 15P. While upper substrate 1 is stacked on lower substrate 4, each of rectangular portions 12P overlaps respective one of spaces 15S, and each of rectangular portions 15P overlaps respective one of spaces 12S.

Cover substrate 7 is a film made of polyethylene terephthalate, or a board made of light-transmittable material, such as glass or acrylic resin.

Upper substrate 1 is placed on upper surface 104 of lower substrate 4 and adhesively stuck to optically light-transmittable adhesive, such as acrylic adhesive or rubber adhesive. Cover substrate 7 is placed on upper surface 101 of upper substrate 1, and adhesively stuck to upper substrate 1 with light-transmittable adhesive, such as acrylic adhesive or rubber adhesive, thus providing touch panel 1000.

In touch panel 1000 according to the embodiment, upper conductive layers 12 arranged in the left/right direction (direction D100) face lower conductive layers 15 arranged in direction D101 perpendicular to direction D100 across upper substrate 1 with a distance, and are electrically independent of lower conductive layers 15.

A method of manufacturing upper conductive layers 12 (lower conductive layers 15) including fine metal particles 12C (15C) made of silver will be described below. First, resin 12A (15A) having metal filaments 12B (15B) dispersed therein is prepared. Then, organic silver salt mixture of organic acid silver salt and amine is added to resin 12A (15A) to prepare resin paste. The amine is primary amine, secondary amine, or tertiary amine. Then, the resin paste is printed on or applied onto upper surface 101 of upper substrate 1 (upper surface 104 of lower substrate 4).

The organic acid silver salt of the organic silver salt mixture is selected from monocarboxylic acid silver salt, such as formic acid silver salt or acetic acid silver salt, keto acid silver salt, such as pyruvic acid silver salt, acetoacetic acid silver salt, or levulinic acid silver salt, glyoxylic acid silver salt, dicarboxylic acid silver salt, such as acetonedicarboxylic acid silver salt, or unsaturated carboxylic acid silver salt, such as propenoic acid silver salt or methacrylic acid silver salt. The amine is selected from primary amine, such as propylamine or cyclohexylamine, secondary amine, such as dimethylamine or ethylhexylamine, or tertiary amine, such as triethylamine or dimethyloctylamine.

Metal filament 12B (15B) is preferably contained in the resin paste by 0.1 wt % to 5 wt % with respect to the total of the resin paste. The organic acid silver salt is preferably contained by 1 wt % to 50 wt % with respect to metal filament 12B (15B), and the amine is preferably contained by 1 wt % to 50 wt % with respect to metal filament 12B (15B).

Upper substrate 1 (lower substrate 4) having the resin paste applied or printed thereon is heated at a temperature ranging from 80° C. to 150° C. to thermally decompose the organic acid silver salt, thereby depositing fine metal particles 12C (15C) of silver on a surface of metal filament 12B (15B) and vaporizing the amine. For instance, in the case that the organic silver salt mixture of silver salt acetate and diethanolamine is used, fine metal particles 12C (15C) made of silver are sintered and attached onto the surfaces of metal filaments 12B (15B). Crossing portions at which the metal filaments 12B (15B) cross each other are linked to each other with fine metal particles 12C (15C). In order to form upper conductive layer 12 (lower conductive layer 15) having the shapes shown in FIG. 2, the resin paste is applied onto substantially entirely upper surface 101 of upper substrate 1 (upper surface 104 of lower substrate 4), and then, has unnecessary portions of the resin paste removed by etching, thereby providing upper conductive layer 12 (lower conductive layer 15) having the shapes shown in FIG. 2.

As described, the resin paste is obtained by adding the organic silver salt mixture of the organic acid silver salt and the amine to resin 12A (15A) having metal filaments 12B (15B) dispersed therein. The resin paste is heated at a temperature not higher than 150° C. Fine metal particles 12C (15C) made of silver and linking metal filaments 12B (15B) are formed on the surfaces of metal filaments 12B (15B). The amine is evaporated and does not remain in upper conductive layer 12 or lower conductive layer 15.

The organic silver salt mixture added to the resin reduces resistances of upper conductive layer 12 and lower conductive layer 15 to 1/5 to 1/20 of a conductive layer which does not include the organic silver salt mixture.

Accordingly, the absolute amount of metal filaments 12B and 15B which cause diffusing reflection can be significantly reduced. Fine metal particles 12C and 15C made of silver deposited by adding the organic silver salt mixture have diameters ranging from several nanometers to several hundred nanometers, which may vary depending on a kind of the added organic silver salt mixture.

Next, a method of manufacturing upper conductive layer 12 and lower conductive layer 15 having fine metal particles 12C made of copper disposed therein will be described below. First, mixture of copper hydride, organic acid, and reducer is added to resin 12A (15A) having metal filaments 12B (15B) dispersed therein, thereby preparing resin paste. Then, the resin paste is printed or applied onto upper surface 101 of upper substrate 1 (upper surface 104 of lower substrate 4).

Metal filaments 12B are preferably contained in the resin paste by 0.1 wt % to 5 wt % with respect to the total amount of the resin paste. The copper hydride mixture is preferably contained in the resin paste by 1 wt % to 50 wt % with respect to metal filaments 12B (15B).

Next, upper substrate 1 (lower substrate 4) having the resin paste applied or printed thereon is heated at a temperature ranging from 80° C. to 150° C. to thermally decompose the copper hydride, thereby depositing fine copper metal particles 12C (15C) on surfaces of metal filaments 12B (15B), and evaporating the organic acid and the reducer which coexist and hydrogen. This process provides fine metal particles 12C (15C) made of copper attached onto the surfaces of metal filaments 12B (15B) and linking crossing portions at which metal filaments 12B (15B) crosses each other. In order to obtain upper conductive layer 12 (lower conductive layer 15) having the shapes shown in FIG. 2, the resin paste may be applied to substantially entirely upper surface 101 of upper substrate 1 (upper surface 104 of lower substrate 4), and unnecessary portions of the applied resin paste are removed by etching, thereby providing upper conductive layer 12 (lower conductive layer 15) having the shapes shown in FIG. 2.

As described above, the mixture of the copper hydrate, the organic acid, and the reducer is added to resin 12A (15A) having fine metals 12A (15A) dispersed therein, thereby preparing the resin paste. The resin paste is heated at a temperature not higher than 150° C. This process provides fine metal particles 12C (15C) made of copper linking metal filaments 12B (15B) on the surfaces of metal filaments 12B (15B). The hydrogen and the coexisted organic acid and the reducer are evaporated by the heating and do not remain in upper conductive layer 12 or lower conductive layer 15. The resistances of upper conductive layer 12 and lower conductive layer 15 can be reduced so that an absolute amount of metal filament 12B, 15B may be reduced.

Then, upper substrate 1 having upper conductive layer 12 thereon, lower substrate 4 having lower conductive layer 15 thereon, and cover substrate 7 are stacked, providing touch panel 1000.

Touch panel 1000 is installed into electronic device 1001 such that lower surface 204 of lower substrate 4 is placed on display surface 1001S of display element 1001A, such as a crystal display element, as shown in FIG. 1B. Upper electrodes 3 and lower electrodes 6 are electrically connected to electronic circuit 1001B of electronic devices 1001 through a flexible wiring board and a connector.

While a voltage is applied from electronic circuit 1001B sequentially to upper electrodes 3 and lower electrodes 6, when a user touches an upper surface of cover substrate 7 with, e.g. a finger of the user according to a display on display surface 1001S of element 1001A behind touch panel 1000. This operation changes a capacitance between upper conductive layer 12 and lower conductive layer 15 at the touched position. Electronic circuit 1001B detects the change in the capacitance, identifying the touched position based on the change in the capacitance, and then, switches functions of electronic device 1001.

For instance, when menus are displayed on display surface 1001S of display element 1001A, the user touches a desired menu on an upper surface of cover substrate 7. Then, an electric charge flows to the finger, and changes the capacitance between upper conductive layer 12 and lower conductive layer 15. Electronic circuit 1001B detects the change in the capacitance, and selects the desired menu.

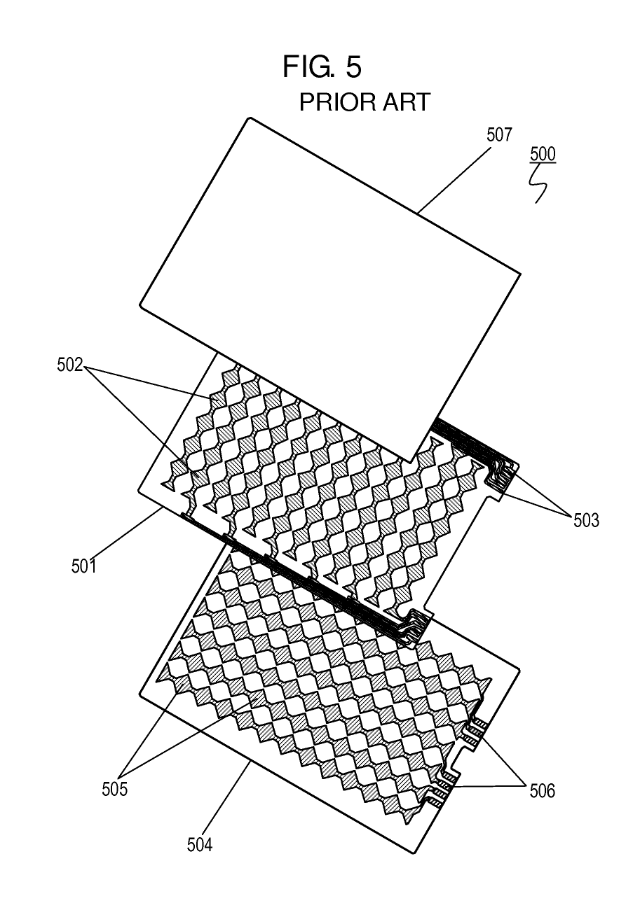

In conventional touch panel 500 shown in FIGS. 4 and 5, when touch panel 500 is used under strong light, outdoor or under sunlight, the light is diffusely reflected by silver filaments 502B and 505B and the silver filaments 502B and 505B look milk white, preventing the user from seeing the display of the backside display element. Meanwhile, a secure operability is demanded for touch panel 500. Such demand requires small resistances of upper conductive layer 502 and lower conductive layer 505.

In touch panel 1000 according to the embodiment, fine metal particles 12C (15C) are attached onto the surfaces of metal filaments 12B (15B) dispersed in light-transmittable resin 12A (15A) in upper conductive layer 12 (lower conductive layer 15). Even when the panel is operated under strong light, outdoor or under sunlight, the display of the display surface 1001S of display element 1001A is prevented from being hardly seen. Therefore, the user can visually confirm the display on display surface 1001S of display element 1001A securely.

That is, fine metal particles 12C (15C) attached onto metal filaments 12B (15B) absorb the light from outside. This prevents metal filaments 12B (15B) from reflecting the light diffusely and look milk white. Even when electronic device 1001 is operated under the sun or under strong light, the diffused reflection of metal filaments 12B, 15B is reduced, thereby allowing the user to see the display of display element 1001A easily and securely operate electronic device 1001.

Moreover, since metal filaments 12B (15B) dispersed in resin 12A (15A) are linked with fine metal particles 12C (15C) having high conductivity, fine metal particles 12C (15C) significantly reduce resistances between metal filaments 12B (15B), hence stabilizing small resistances of upper conductive layer 12 and lower conductive layer 15. This configuration reduces the amount of dispersed metal filaments 12B and 15B, further reducing the diffused reflection of metal filaments 12B and 15B.

As described above, the resin paste is prepared by adding the organic silver salt mixture of the organic acid silver salt and the amine (primary amine, secondary amine, or tertiary amine) or the mixture of the copper hydride and the organic acid and the reducer to the resin 12A (15A) having metal filaments 12B (15B) dispersed therein. The resin paste is then heated at a temperature not higher than 150° C., thereby providing fine metal particles 12C (15C) of silver or copper attached onto the surfaces of metal filaments 12B (15B) and linking metal filaments 12B (15B). This heating forms upper substrate 1 and lower substrate 4 relatively easily while upper substrate 1 and lower substrate 4 are not affected by the heat. The amine added in the organic acid silver salt or the hydrogen or coexisted organic acid and the reducer are evaporated by the heat and do not remain in upper conductive layer 12 or lower conductive layer 15. Therefore, the resistances of upper conductive layer 12 and lower conductive layer 15 does not increase due to such residue and the resistances of upper conductive layer 12 and lower conductive layer 15 is stably small.

In touch panel 1000 according to the embodiment, upper substrate 1 having upper conductive layers 12 provided on upper surface 101 thereof is stacked on lower substrate 4 having lower conductive layers 15 provided on upper surface 104 thereof such that upper conductive layers 12 face lower conductive layers 15 with a predetermined gap therebetween and electrically independently of each other. In touch panel 1000 according to the embodiment, upper conductive layers 12 may be provided on upper surface 101 of upper substrate 1 and lower conductive layers 15 may be formed on lower surface 201 of upper substrate 1 instead of lower substrate 4. Still more, upper conductive layers 12 and lower conductive layers 15 perpendicular to upper conductive layers 12 may be formed on upper surface 101 of upper substrate 1 electrically independently of each other.

In touch panel 1000 according to the embodiment, in each of upper conductive layer 12 and lower conductive layer 15, metal filaments 12B (15B) having fine metal particles (12C (15C) attached onto surfaces thereof are dispersed in resin 12A (15A), and metal filaments 12B (15B) are linked with fine metal particles 12C and 15C. In another touch panel according to the embodiment, either one group of the group of upper conductive layers 12 and the group of lower conductive layers 15 may be made of light-transmittable indium tin oxide or tin oxide and may not include the metal filaments or the fine metal particles.

In touch panel 1000 according to the embodiment, display surface 1001S of display element 1001A is easy to see and the panel is securely operable, and the panel is useful for operating electronic device 1001.

In the embodiment, terms, such as “upper”, “lower”, “left/right”, and “front/back”, indicating directions merely indicate relative directions dependent on a relative positional relationship of constituents, such as upper substrate 1 and lower substrate 4, of touch panel 1000, and do not indicate absolute directions, such as a vertical direction.

What is claimed is:

1. A touch panel comprising:
a plurality of first conductive layers being light-transmittable having strip shapes arranged in a predetermined direction; and
a plurality of second conductive layers being light-transmittable having substantially strip shapes arranged in a direction perpendicular to the predetermined direction, the plurality of second conductive layers facing the plurality of first conductive layers with a gap between each of the plurality of second conductive layers and each of the plurality of first conductive layers,
wherein each of the plurality of first conductive layers includes:
a first resin being light-transmittable;
a plurality of first metal filaments dispersed in the first resin; and
a plurality of first fine metal particles dispersed in the first resin, the plurality of first fine metal particles electrically connecting the plurality of first metal filaments to each other.

2. The touch panel according to claim 1, wherein the plurality of first fine metal particles are made of silver or copper.

3. The touch panel according to claim 1, wherein each of the plurality of second conductive layers includes;
a second resin being light-transmittable;
a plurality of second metal filaments dispersed in the second resin; and
a plurality of second fine metal particles dispersed in the second resin, the plurality of second fine metal particles electrically connecting the plurality of second metal filaments to each other.

4. The touch panel according to claim 3, wherein the plurality of second fine metal particles are made of silver or copper.
